(19) United States
(12) Patent Application Publication
(10) Pub. No.: US 2013/0298336 A1
(43) Pub. Date: Nov. 14, 2013

(54) Massaging Bed With Massager Spaced From Massager Drive

(71) Applicant: Innovative Standards, Inc., Lenexa, KS (US)

(72) Inventor: Daniel W. Jones, Overland Park, KS (US)

(21) Appl. No.: 13/864,036

(22) Filed: Apr. 16, 2013

Related U.S. Application Data
(63) Continuation of application No. 13/479,716, filed on May 24, 2012, now Pat. No. 8,418,298.
Application No. 13/479,716 is a continuation of application No. 12/731,404, filed on Mar. 25, 2010, now Pat. No. 8,201,293.
Application No. 12/731,404 is a continuation of application No. 11/504,406, filed on Aug. 15, 2006, now Pat. No. 7,712,172.

(51) Int. Cl. A61H 15/00; A47C 27/14

(52) U.S. Cl. CPC A61H 15/0078; A47C 27/14
USPC 5/740; 5/690

(57) ABSTRACT

A method and apparatus for a sleep system is provided. More specifically, the invention provides a method and apparatus for an adjustable mattress that allows the user to increase or decrease the firmness of the mattress. Furthermore, the adjustable mattress has zones of adjustability thereby allowing two users to adjust the firmness of the mattress of each user's zone. The adjustable mattress is also multimodal. The motorized foundation contains adjustable massaging units that may be used for physical therapy and relaxation. Likewise, the motorized foundation may be used in relax mode to assist in obtaining sleep and awaken mode to gently awake the user by the stimulation of the adjustable mattress.

### FIELD OF THE INVENTION

This invention relates to a bed for resting and sleeping. More specifically, the invention provides a method and apparatus for an adjustable mattress that allows the user to increase or decrease the firmness of the mattress. Alternatively, the adjustable mattress has zones of adjustability thereby allowing two users to adjust the firmness of the mattress of each user's zone. The adjustable mattress is also multimodal. The motorized foundation may contain adjustable massaging units that may be used for physical therapy and relaxation. Alternatively, the motorized foundation may be used in relax mode to assist in obtaining sleep and awaken mode to gently awake the user by the stimulation of the massaging mechanism.

### BACKGROUND OF THE INVENTION

Sleeping mattress and design are typically of three forms: foam and batting, water bladders, or air bladders. A traditional mattress and foundation combination utilizes a box spring having a series of vertical springs arranged along the entire width and length of the box spring. These provide support for the mattress that is placed on top. The mattress may have various internal components such as vertical springs, wiring, cording, and soft batting materials such as cotton and foam. The firmness of the mattress is a function of the combination of compressive properties of each material. A firm mattress may utilize stiff vertical springs and a dense foam and cotton batting on top to form a “pillow-top”. One limitation of these traditional mattress and box-spring combinations is that the firmness of the mattress system can only be achieved by replacing the components. Likewise, the firmness of the mattress changes with age of the materials and worn areas or depressed areas may develop.

Water bladders, or more commonly known as waterbeds utilize a bladder, which is filled with water. The firmness of the bed is controlled by the amount of water in the bladder and resulting fluid pressure. Various bladder designs are also available which provide wave support to prevent the water in the bladder from creating a wave. Also multiple bladders may be used to provide various zones of firmness. Like the traditional mattress and box-spring design, adding or removing water may only change the firmness of the water bladder bed. Water has a disadvantage over conventional mattress in that when weight is applied to one location, the displaced water raises the bladder in another area. Another disadvantage of these mattresses is the fact that the bladder can be compromised resulting in the water leaking from the mattress.

The third most common bed configuration is the air mattress. Like a waterbed, the air mattress utilizes a bladder or multiple bladders filled with air. One type of airbed configuration allows two users to adjust each side of the bed independently. The user may adjust the firmness of the bed by pumping air into or removing air from the bladder. The most common types of airbeds typically do not allow the user to adjust the firmness along the length of the bladder such as firmer along the area of the user's lower back is positioned and softer at the head of the bed. A multiple bladder system, using more that one bladder per sleeping area could be used to provide adjustable comfort. However, bladder systems, both air and water, have a disadvantage over conventional mattress in that when weight is applied to one location, the displaced air or water raises the bladder in another area. Thus, if the bladder system is set as soft, a heavy person's mass displaces more air or water at the heaviest areas such as the hips, which raises the head or foot area.

Another alternative of conventional and air or water bladders, is the foam bed. These foam systems may be composed of polyurethane or urethane foams. These mattresses may be used with a conventional box spring and the mattress itself may utilize foam of different densities along the length of the mattress or even spring systems. A disadvantage of the foam bed is that firm of the mattress cannot be adjusted and the foam subject to fatigue and loss of its rigidity.

Recent developments in foam systems include those mattress pads of visco-elastic foams such as Contour-Foam™, Tempurpedic®, Isotonic™ and similar foams. These may be used on top of traditional, air or waterbed to increase the comfort of the bed. Also, new mattress systems use the visco-elastic as a top portion with various foam bases or conventional spring systems. These types of foams conform to the body and provide reduced pressure support. A disadvantage of these systems is that they are not adjustable. Like a traditional mattress, both the visco-elastic foam and urethane foam mattresses need to be flipped and rotated to prevent localized fatigued areas.

Hospital style beds often use the visco-elastic foam to help prevent pressure sores (subcutaneous ulcers) on bed-confined patents. Most hospital beds have adjustable positions, however, they do not provide adjustable firmness along the length of the bed. Hospitals also utilize air mattress systems that may utilize an active air pump to maintain the pressure in the mattress. These air pumps are typically noisy and often disturbing to the patient.

Although the above bed systems provide various methods of support, they lack the ability to provide adjustability of firmness along the length of the bed (i.e. from foot to head). Furthermore, the above bed systems provide only one function—a place to sleep. Thus, it is desirable to have a sleep system that provides for adjustable firmness at multiple locations along the mattress. Furthermore, it is desirable to have a system that provides alternate functions such as compressive massaging. Beside the relaxing properties of massage to aid sleep, massage is also beneficial to persons confined to bed for the relief of localized pressure and increase blood flow to the area of pressure. Likewise, it is desirable to have a bed system that provides an alternative means of wakening such as vibration or even a gentle massage. This type of awaking means is also desired by the hearing impaired.

Previous attempts have been made to provide for automatic massage on a table or bed like foundation. U.S. Pat. No. 3,503,524 by Wilson, utilizes a table platform with foam placed on top. Massaging rollers on a conveyor belt system is located beneath the surface of the table. To make contact with the person lying on the table, a slot having a width greater than the roller is cut into the table and foam and the massaging roller protrudes through the slot. The conveyor belt utilizes multiple rollers, but only provides massage in the area of the slot in the table. As disclosed, the table can take the form of a bed by placing a cushion insert in the slot. This requires the user to get up from the table, retrieve the cushion and place it into the slot. This step is often undesirable such as the case when the user desires the massage to help him or her to relax, reduce tension and assist the person in obtaining sleep. Likewise, if the user falls asleep on the table with the massaging roller intact, the person may roll onto the roller or respond to the roller by moving over. The location of the roller or element is very undesirable in a bed. The cushion for the slot would need a stiff backing to prevent the user's weight from compressing it to prevent the cushion from molding to the belt and roller below. Thus, a massaging bed that automatically converts into a bed without the user getting out or having to move over on the bed to replace a cushion in the bed is desired.

Advances have been made in massaging chairs and recliner models are available.

These reclining chairs can provide a very comfortable massage, but also carry a warning that states that the chair is not for sleeping in. Besides the fact that these chairs do not have significant padding between the massaging rollers or massaging heads. This provides significant contact or force into the muscle of the user. Massage chairs are designed to support the user's weight at the seat pan or the chair, arm rests and leg rests. These areas will have more padding and substructure and the quality of the massage is typically less than those areas without the extra padding. These areas requiring padding present problems to the designer. The padding used in the chair must be able to withstand the repetitive action of the massagers that create friction, heat and wear of the padding. In fact, U.S. Pat. No. 7,004,916 to Dehli, recognizes that it is desirable to have chair massager “that preferably does not rattle with age, does not wear away the chair fabric at a considerable rate, and is safe to the user.” Likewise, U.S. Pat. No. 6,881,195 to Wu also discusses the need for a fabric for a chair massager that can withstand the wear of the massage rollers, especially in the hollow area of the chair that does not contain significant padding.

In accordance with these and other objects evident from the following description of the preferred embodiments, the present invention provides a method and apparatus for a multifunctional and multidimensional adjustable firmness sleep system that provides multiple sleep modes, relaxation, sleep and gentle awakening.

One embodiment utilizes a foam mattress placed on a multimodal and powered foundation with a timing device having a user interface.

A second embodiment utilizes foam and powered foundation having pistons and rollers to provide adjustable firmness and massaging and vibration.

A third embodiment utilizes foam and air solenoids to achieve adjustable firmness and provide massaging and vibration.

A fourth embodiment utilizes foam and a powered foundation with pneumatically controlled actuators.

A fifth embodiment utilizes foam and alternative mechanical methods of achieving adjustable firmness and massaging and vibration.

A sixth embodiment utilizes an algorithm to progressively reduce the massaging action to assist in obtaining sleep. This embodiment may alternatively use air noise or other mechanically produced white noise to further assist in obtaining sleep.

Other aspects and advantages of the present invention will be apparent from the following detailed description of the preferred embodiments and the accompanying drawing figures.

### BRIEF DESCRIPTION OF THE DRAWINGS

FIG. 1a-c is a side plan view of a prior art bed illustrating conventional, air or water bladder mattress system.

FIG. 2 is a side plan view of the multimodal sleep system.

FIG. 3 is a plan view of the mattress along line A-A of FIG. 2.

FIG. 4 is a bottom plan view of mattress having slots for receiving massagers.

FIG. 5 is a portion of a cross-sectional view of the side of the sleep system powered foundation illustrating one set of massagers and its drive system of one embodiment.

FIG. 6 is a top plan view of the sleep system powered foundation having mechanically and independently adjustable support members.

FIG. 7 is a cut-way view of a messaging member cut along line A-A and B-B of the side view of the massager actuator.

### DETAILED DESCRIPTION OF THE INVENTION

The invention may be embodied in various forms; however, the invention is described with respect to the following embodiments.

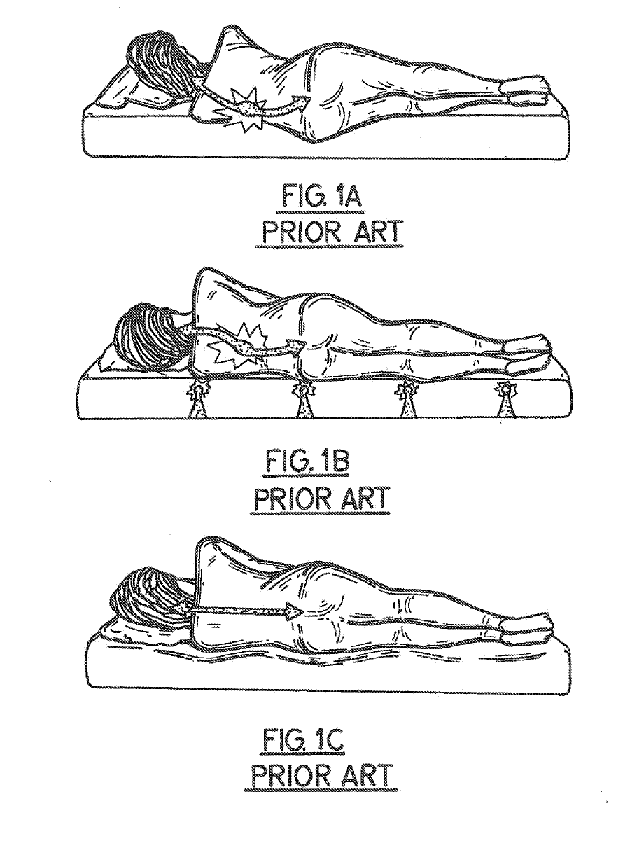

Prior art bed systems typically use a mattress having some type of foam or other foam and cotton batting materials which may not provide adequate support for the user. FIG. 1C illustrates a foam or foam and cotton batting mattress that does not provide adequate support. The heaviest areas of the user compresses the foam more that the lighter areas. As illustrated in FIG. 1C, the user's spine is out of alignment placing pressure the user's shoulder, neck and lower back. In contrast, a mattress that is too stiff provides inadequate support of the contours of the user's body and places pressure on the user's shoulder, hip, knee and ankle as illustrated in FIG. 1B. The best possible posture for sleep is shown in FIG. 1C. The user's spine is in natural alignment and the mattress evenly supports the user's body

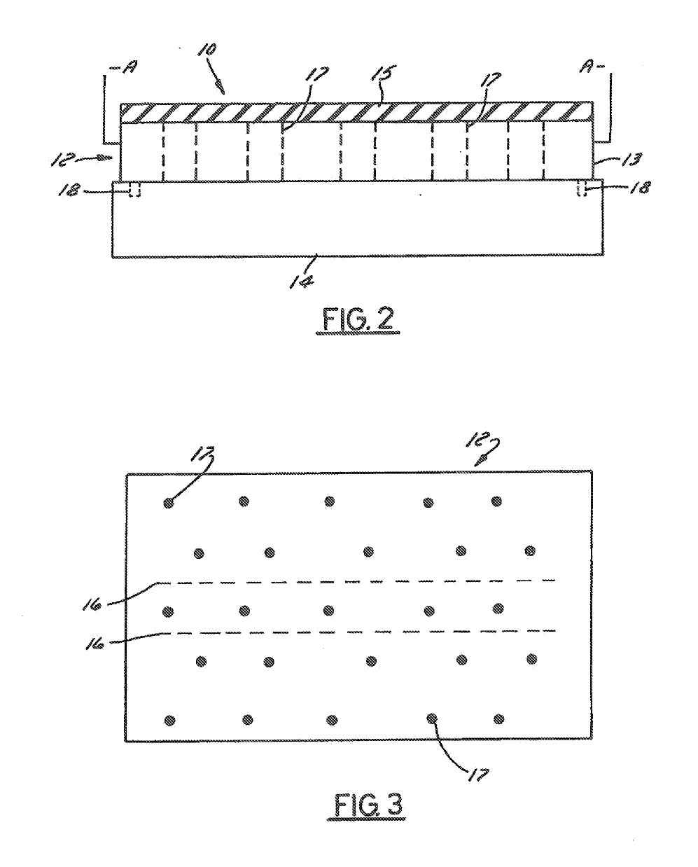

Turning to FIG. 2, one embodiment of sleep system 10 utilizes a visco-elastic foam mattress 12 and a powered foundation 14. In one embodiment, mattress 12 is composed of a mattress body 13 and mattress topper 15. Foam mattress body 13 contains slits 16 that appear like a thin cut in the foam mattress body 13. FIG. 3 illustrates the slits 16 that originate from the underside of mattress body 13 and mates with apparatus (not shown) contained in power foundation 14. Returning to FIG. 2, restraining member 17 is utilized to maintain a nearly flat surface on the top of mattress 12. Restraining member 17 may be composed of various cording material such nylon, wire, plastic, cotton or similar materials having rigidity. Mattress jacket (not shown) covers mattress 12 and encases mattress body 13 and mattress topper 15. An alignment guides in the form of pins 18 are used to ensure that mattress 12 is aligned with powered foundation 14 and is received in a corresponding hole in powered foundation 14.

Illustrated in FIG. 3 is a cutaway view along plane A-A of FIG. 2 of mattress 12 illustrating the slits 16 that transverse the thickness of foam mattress body 13 from the bottom of foam mattress body 13. Slit 16 opens when the massaging apparatus 21 (not shown) travels vertically from powered foundation 14 through slit 16 to mattress topper 15. Silt 16 is substantially closed at all times and is made by cutting a slit in foam mattress 12. In contrast, a slot, where foam is removed from the cut, cannot close and leave an interrupted surface. When force is applied to mattress topper 15 with a slotted submattress, that area of the mattress containing a cut, topper 15 sags in the areas above the slots. Therefore, slit 16 is a preferred method of cutting foam mattress 12. Also shown is restraining member 17. Multiple slits 16 may be used along foam mattress 12 to obtain the desired massaging travel pathways or similar function.

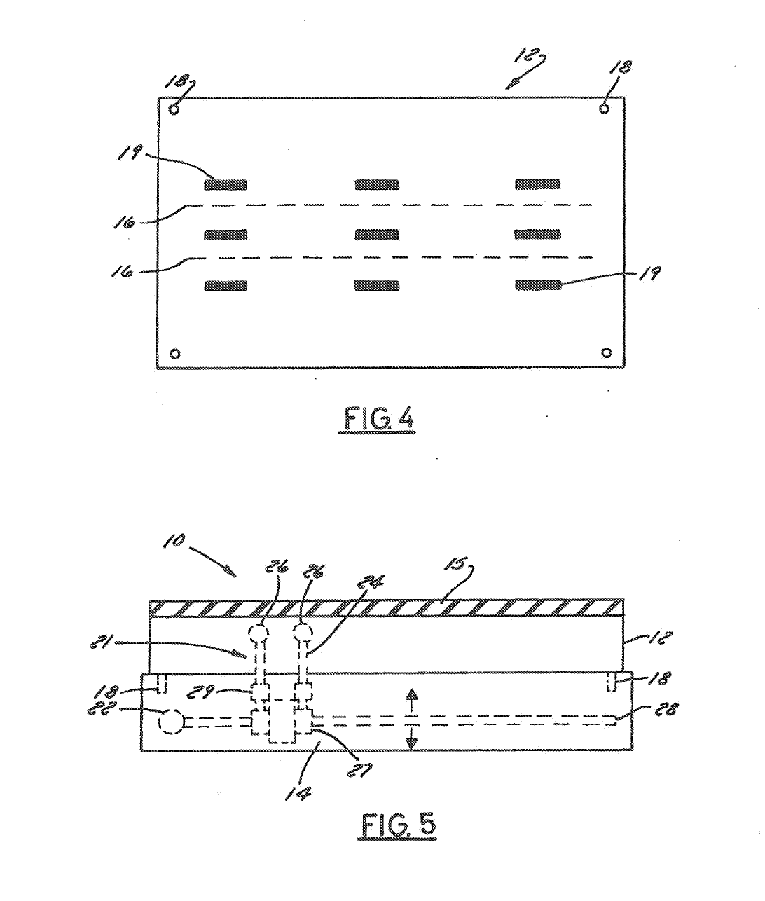

The bottom of foam mattress 12 is illustrated in FIG. 4. The opening of slits 16 are shown and various numbers of slits 16 may be used. Also seen in FIG. 4 are loop and hook fasteners 19, such as Velcro®. These provide an additional attachment point along with pins 18 to secure mattress 12 to powered foundation 14. However, various fastener systems may be used to secure mattress 12 to powered foundation 14. Slits 16 may be are lined with material containing polytetrafluoroethylene (Teflon®), silicon, tungsten disulfide or other low friction coating to allow the massaging members (not shown) to travel upward through slits 16 to mattress topper 15.

An alternative sleep system 10 is shown in FIG. 5. Mattress 12 sits on top of power foundation 14 as illustrated. Massage actuators 24 are received in mattress slits 16 (shown in FIG. 4) of foam mattress 12. Massager 26 is also received in slit 16 of foam mattress 12 and provides compressive massage as they move along mattress 12 in slits 16. As stated above, slits 16 may be are lined with a fabric containing a low friction coating or fabric impregnated with a low friction material. Foam mattress 12 is composed of open-cell, visco-elastic memory foam and may be composed of multiple layers such as 3 pound density foam submattress (the portion of mattress 12 containing slits 16) and a denser foam, 4 or 5 pound density, for mattress topper 15. As massaging apparatus 21 travels upward from powered foundation 14, massaging apparatus 21 splits open slit 16. Slits 16 are substantially closed when massaging apparatus 21 is retracted in powered foundation 14 or is passed by and foam mattress 12 appears to be a solid mattress. Furthermore, when fully retracted, the resistive compressive properties the slitted submattress of foam mattress 12 remains virtually identical to that of a non-slitted foam mattress of identical foam type and density. Vibrating motors 29 provides vibrating action to massager 26. Likewise, y-axis motor 27 provides massager actuator 24 with up and down massaging action. Mattress topper 15 is an uninterrupted surface and has sufficient foam above massager 26 to provide comfort to the user. Mattress topper 15 may also contain a low friction material or coating where slits 16 stop at mattress topper 15 to reduction wear of mattress topper 16 and reduce frictional heat.

FIG. 7 illustrates massaging apparatus 21 and a cross-sectional view of massage actuator 24. Massage actuator 24 has an aerodynamic cross-sectional shape as such as those shown in FIG. 7, view A-A and B-B. These shapes help assist in the opening of slits 16 as the massage actuator 24 travels to massage locations and close slit 16 behind it. Section B-B is shaped such that the leading and trailing edges are curved to open slit 16 and separates as the foam as it travels pasts the side of massage actuator 24 to progressively close. Low friction coatings may be added to massage actuator 24 to reduce friction and abrasion. Various designs of massage actuator 24 may be utilized. The section shown in B-B separates the slit with low friction and the side shapes, the angled and flat surfaces to minimize the high-pressure regions and therefore reduce the fatigue ear to slits 16. Slits 16 must remain substantially closed to keep the uniformity of foam mattress 12. If slits 16 are allowed to stay open, foam mattress 12 collapses.

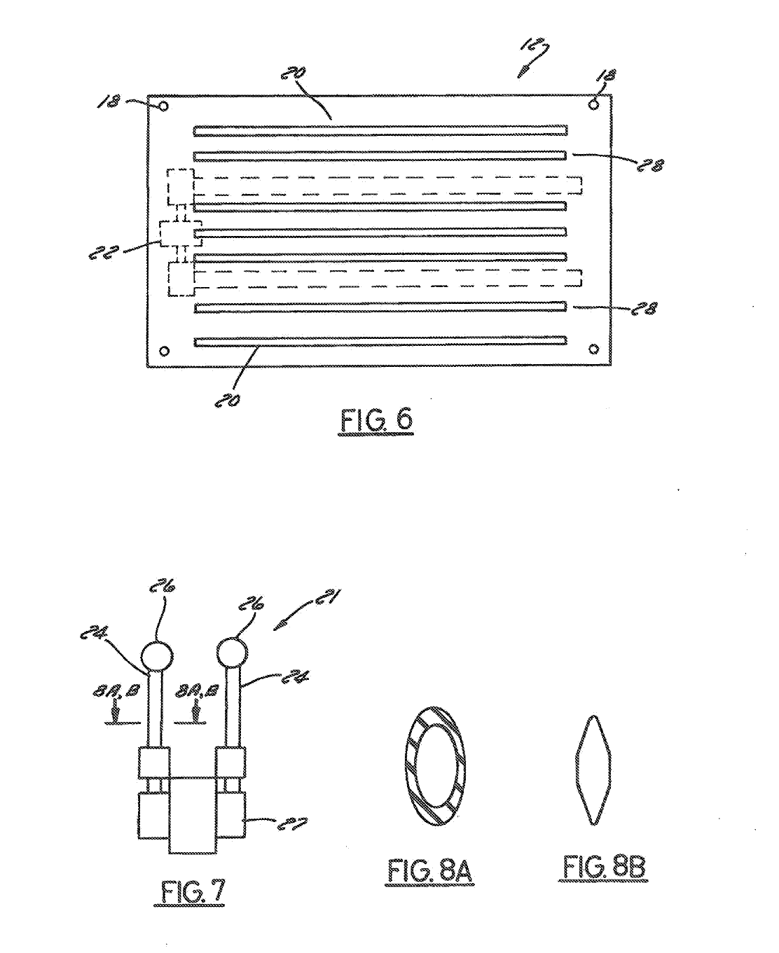

In an embodiment shown in FIG. 6, motor 22 and cam 28 can be used to provide actuation power to drive shaft 28 which provides longitudinal positioning for massage actuators 24 and massager 26. Additional motors (not shown) perform other functions such driving massager 26 inboard or outboard or providing vibration. Motor (not shown) may be used to drive an elastic cable system (not shown) to drive mechanical actuator 24 and massager 26, drive shaft 28 and associated motor 22 to hoist this assembly vertically upward to mattress topper 15 and user and provide various compressive forces (massage). Alternative, this elastic cable system (not shown) may be used to lower the massaging assembly away from user, to reduce either gradually or abruptly reduce the massaging pressure. This elastic cable system allows the massaging assembly to follow the counter the user's body. Alternative, air controlled actuators may be alternatively utilized in place of mechanical actuator 24. Likewise, various massaging contacts may be utilized in lieu of massager 26.

One embodiment of an actively adjustable firmness sleep system is shown in FIG. 6 that illustrates powered foundation 14 with support members 20. A motor 22 actuates support members 20 via a camshaft 28. To adjust the firmness of foam mattress 12, a support member 20 is raised which locally compresses mattress body 13. A variety of support members 20 can be utilized along the length of foam mattress 12. Multiple motor 22 and cam systems may be utilized to provide support or softness along the foam mattress 12. Support members 20 may be composed of various materials such as wood, plastic, metal, fiberglass, carbon epoxy and other materials.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. A massaging bed comprising:
a mattress; and
a massaging apparatus having (a) a massager drive, and (b) a massager spaced from the massager drive.

48. The massaging bed of claim 47 wherein the mattress has a person-supporting sleep surface overlying the massager, and wherein the massager is disposed within the mattress, the massager underlies the person-supporting sleep surface, and the massager is carried by an elongate connector that extends from the massager drive to the massager spacing the massager from the massager drive.

49. The massaging bed of claim 48 wherein the elongate connector extends generally upwardly from the massager drive to the massager, and wherein at least a portion of the elongate connector is disposed within the mattress.

50. The massaging bed of claim 49 wherein the massager drive further comprises a motor that moves the massager and the elongate connector within the mattress relative to the person-supporting sleep surface of the mattress along the person-supporting sleep surface of the mattress.

51. The massaging bed of claim 50 wherein the elongate connector comprises a massage actuator connecting the massager to the massager drive.

52. The massaging bed of claim 50 wherein the massager comprises a vibrating massager.

53. The massaging bed of claim 52 wherein the massager drive comprises a vibrator that vibrates the vibrating massager.

54. The massaging bed of claim 53 wherein the vibrator comprises a second motor.

55. The massaging bed of claim 47 wherein the mattress has a portion that is resiliently deformable overlying the massager and wherein the massager is connected to the massager drive by an elongate connector spacing the massager from the massager drive.

56. The massaging bed of claim 55 wherein the elongate connector comprises a massage actuator.

57. The massaging bed of claim 55 wherein the massager drive moves the massager and elongate connector relative to the resiliently deformable portion of the mattress that overlies the massager.

58. The massaging bed of claim 57 wherein the massager and at least a portion of the elongate connector are disposed within the mattress.

59. The massaging bed of claim 55 wherein the resiliently deformable portion of the mattress is comprised of foam.

60. The massaging bed of claim 55 wherein the mattress, including the resiliently deformable portion of the mattress, is comprised of foam.

61. The massaging bed of claim 55 further comprising a foundation that carries the mattress and wherein the massager drive is carried by the foundation with the elongate connector extending from the massager drive generally upwardly into the mattress disposing the massager inside the mattress.

62. The massaging bed of claim 47 further comprising a foundation upon which the mattress is supported, the foundation carrying the massager drive with the massager disposed inside the mattress and spaced from the massager drive by an elongate connector.

63. The massaging bed of claim 62 wherein the massager drive is disposed within the foundation and the elongate connector extends from the massager drive generally upwardly into the mattress connecting the massager to the massager drive.

64. The massaging bed of claim 63 wherein a portion of the mattress overlies the massager.

65. The massaging bed of claim 64 wherein the portion of the mattress overlying the massager is comprised of foam.

66. The massaging bed of claim 63 wherein the mattress is comprised of visco-elastic foam.

67. The massaging bed of claim 62 wherein the massager comprises a vibrating massager.

68. The massaging bed of claim 67 wherein the massager drive comprises a vibrator that vibrates the vibrating massager.

69. The massaging bed of claim 68 wherein the vibrator comprises a motor.

70. The massaging bed of claim 62 wherein the massager drive further comprises a motor that moves the massager within the mattress relative to the mattress along the mattress.

71. The massaging bed of claim 62 wherein the massager drive further comprises a motor that moves the massager and elongate connector relative to the mattress along the mattress.

72. A massaging bed comprising:
a foundation;
a mattress overlying the foundation; and
a massaging apparatus having (a) a massager drive disposed in the foundation, and (b) a massager spaced from the massager drive by an elongate connector, the massager disposed in the mattress.

73. The massaging bed of claim 72 wherein the elongate connector comprises a massage actuator connecting the massager to the massage drive.

74. The massaging bed of claim 72 wherein the mattress has a person-supporting sleep surface overlying the massager.

75. The massaging bed of claim 74 wherein the mattress further comprises a portion that is resiliently deformable overlying the massager.

76. The massaging bed of claim 75 wherein the resiliently deformable portion of the mattress is comprised of foam.

77. The massaging bed of claim 76 wherein the mattress is comprised of foam.

78. A massaging bed comprising:
a foundation;
a mattress of resiliently deformable construction that is supported by the foundation, the mattress having a person-supporting sleep surface overlying a portion of the mattress comprised of foam; and
a massaging apparatus having (a) a vibrating massager disposed in the mattress, the vibrating massager underlying the foam portion and the person-supporting sleep surface, (b) an elongate connector carrying the vibrating massager, the elongate connector extending upwardly from the foundation into the mattress, and (c) a massager drive disposed in the foundation that moves the elongate connector and vibrating massager relative to the mattress underneath and along the foam portion of the mattress.

79. The massaging bed of claim 78 wherein the elongate connector comprises a massage actuator connecting the vibrating massager to the massager drive.

80. The massaging bed of claim 78 wherein massager drive comprises a first motor that moves the elongate connector and massager relative to the mattress and a second motor that vibrates the vibrating massager.
